(19) United States
(12) Patent Application Publication
(10) Pub. No.: US 2002/0085097 A1
(43) Pub. Date: Jul. 4, 2002

(54) Computer vision-based wireless pointing system

(76) Inventors: Antonio J. Colmenarez, Peekskill, NY (US); Eric Cohen-Solal, Ossining, NY (US); Daphna Weinshall, Croton-on-Hudson, NY (US); Mi-Suen Lee, Ossining, NY (US)

Correspondence Address: Corporate Patent Counsel, U.S. Philips Corporation, 580 White Plains Road, Tarrytown, NY, 10591, US

(21) Appl. No.: 09/746,045

(22) Filed: Dec. 22, 2000

(51) Int. Cl. H04N 5/232; H04N 5/222; H04N 5/225

(52) U.S. Cl. 348/211; 348/333.02; 348/375

(57) ABSTRACT

A system comprising at least one light source in a movable hand-held device, at least one light detector that detects light from said light source, and a control unit that receives data from the at least one light detector. The control unit determines the position of the hand-held device in at least two-dimensions from the data from the at least one light detector and translates the position to control a feature on a display.

### BACKGROUND OF THE INVENTION

1. Field of the Invention

The present invention relates to a wireless pointing system, and more particularly to a wireless pointing system that determines the location of a pointing device and maps the location into a computer to display a cursor or control a computer program.

2. Description of the Related Art

Pointing devices such as a computer mouse or light pen are common in the computer world. These devices not only assist a user in the operation of a computer, but are also at a stage in their development to free the user from needing an interface that is hardwired to the computer. One type of wireless device now available, for example a wireless mouse, utilizes a gyroscopic effect to determine the position of the pointing device. This information is converted into digital positional data and output onto a display as, for example, a cursor. The problem with these pointing devices is that they rely on the rotation of the device rather than translation. Rotational devices decrease accuracy, and the devices are relatively heavy, as they require the mass to exploit the principle of momentum conservation.

Also available are pointing devices that transmit light having a particular wavelength. The light is detected by a receiver and translated into positional data for a cursor on a display. These devices, though much lighter and less expensive than their gyroscopic counterparts, are limited to the particular wavelength selected for transmission and detection.

Control devices that incorporate light sources to control remote devices are commercially available. The most common of these devices are those that operate home audio and video equipment, for example, a VCR, television, or stereo. These systems include a remote device or transmitter, and a main unit having a light sensor or receiver. The remote devices utilize an infrared light source to transmit command signals. The light source, usually a light emitting diode (LED), flashes at specific frequencies depending on the command to be transmitted to the main unit. The command signal transmitted from the remote is detected by the receiver, and translated into a control signal that controls the main unit. The LED and the receiver operate on the same wavelength to enable the detection of the light signal and proper communication. This wavelength-matching design constraint reduces the compatibility of the receiver to transmitters of a single wavelength, among other things.

Digital cameras are also readily available on the commercial market. The standard technologies of digital cameras are based primarily on two formats: charged coupled device (CCD) and complementary metal oxide semiconductor (CMOS) sensors. CCD sensors are more accurate, but costly compared to CMOS sensors, which forgo accuracy for a substantial cost reduction. Though each device processes an image differently, both utilize the same underlying principle in capturing the image. An array of pixels is exposed to an image through a lens. The light focused onto the surface of each pixel varies with the portion of the image captured. The pixels record intensity of light incident thereon when an image is captured, which is subsequently processed into a form that is viewable.

### SUMMARY OF THE INVENTION

It is an objective of the present invention to provide a system that enables a commercially available hand-held device, such as a remote, to be used as a pointing device, cursor, or other feature control on a display. It is a further objective to provide a system that detects the flashing light emitted by an LED, for example, of such a hand-held device, without regard to the wavelength or frequency, and to use the detection to provide a pointing device or other feature control. It is a further objective of the invention to use a standard digital camera(s) and image detection and recognition processing in the system, without the need to calibrate these components. It is also an objective of the invention to provide a system that can detect a movement of the hand-held device in three dimensions, as well as three angular degrees of freedom, and provide a corresponding movement of a feature in a 3D rendering on a display.

The present invention provides a system that comprises a hand-held device having a light emitting LED. The light emitting from the LED is detected in an image of the device captured by at least one digital camera. The detected position of the device in the 2D image is translated to corresponding coordinates on a display. The corresponding coordinates on the display may be used to locate a cursor, pointing device, or other movable feature. Thus, the system provides movement by the cursor, pointing device, or other movable feature on the display that corresponds to the movement of the hand-held device in the user's hand.

With the incorporation of more than one digital camera, change in depth of the hand-held device may also be determined from the image. This may be used to locate a cursor, pointing device, or other movable feature in a 3D rendering. Thus, the system provides movement by the cursor, pointing device, or other movable feature in the 3D rendering on the display that corresponds to 3D movement of the hand-held device in the user's hand.

With the incorporation of more than one LED in the hand-held device the system may also detect rotational motion (and thus detect motion corresponding to all six degrees of freedom of movement of the device). The rotational motion may be detected by using at least two LEDs in the hand-held device that emit light at different frequencies and/or different wavelengths. The different frequencies and/or wavelenths of the two (or more) LEDs are detected in the image of the cameras and distinguished by the processing. Thus, rotation in subsequent images may be detected based on the relative movement of the light emitted from the two LEDs. The rotational motion of the hand-held device may also be included in the 3D rendering of the point on the display, as described above (as well as corresponding movement of a cursor, pointing device, or other movable feature in the 3D rendering).

The system of the present invention may also compensate for the movement of the user holding the hand-held device. Thus, if the user moves, but the device remains stationary with respect to the user, for example, there is no movement of the cursor, pointing device, or other movable feature on the display. Thus, for example, the system uses image recognition to detect movement of the user and to distinguish movement of the hand-held device from movement of the user. For example, the system may detect movement of the hand-held device when there is movement between the hand-held device and a reference point located on the user.

The invention also comprises a system comprising at least one light source in a movable hand-held device, at least one light detector that detects light from said light source, and a control unit that receives image data from the at least one light detector. The control unit detects the position of the hand-held device in at least two-dimensions from the image data from the at least one light detector and translates the position to control a feature on a display.

The at least one light detector may be a digital camera. The digital camera may capture a sequence of digital images that include the light emitted by the hand-held device and transmit the sequence of digital images to the control unit. The control unit may comprise an image detection algorithm that detects the image of the light of the hand-held device in the sequence of images transmitted from the digital camera. The control unit may map a position of the detected hand-held device in the images to a display space for the display. The mapped position in the display space may control the movement of a feature in the display space, such as a cursor.

The at least one light detector may comprise two digital cameras. The two digital camera each capture a sequence of digital images that include the light emitted by the hand-held device, and each sequence of digital images is transmitted by each camera to the control unit. The control unit may comprise an image detection algorithm that detects the image of the light of the hand-held device in each sequence of images transmitted from the two digital cameras. The control unit may in addition comprise a depth detection algorithm that uses the position of the light source in the images received from each of the two cameras to determine a depth parameter from a change in a depth position of the hand-held device. The control unit maps a position of the detected hand-held device in at least one of the images from one of the cameras and the depth parameter to a 3D rendering in a display space for the display. The mapped position in the display space controls the movement of a feature in the 3D rendering in the display space.

The at least one light detector may also comprise at least one digital camera and the hand-held device may comprise two light sources. The digital camera may capture a sequence of digital images that include the light from the two light sources of the hand-held device, and the sequence of digital images is transmitted to the control unit. The control unit may comprise an image detection algorithm that detects the image of the two light sources of the hand-held device in the sequence of images transmitted from the digital camera. The control unit determines at least one angular aspect of the hand-held device from the images of the two light sources. The control unit maps the at least one angular aspect of the hand-held device as detected in the images to a display space for the display.

Still further, additional functions can be added to the hand-held device to incorporate standard mouse and other control features therein, thus enabling the invention to function as a more full-functioned pointing device.

### BRIEF DESCRIPTION OF THE DRAWINGS

The above and other aspects, features and advantages of the present invention will become more apparent from the following detailed description when taken in conjunction with the accompanying drawings in which:

FIG. 1 is a representative view of the wireless pointing device system according to a first embodiment of the present invention;

FIG. 1a is an exploded view of an internal portion of one of the components shown in FIG. 1;

FIG. 2 is a representative view of the wireless pointing device system according to a second embodiment of the present invention;

FIG. 3 is a representative view of the wireless pointing device system according to a third embodiment of the present invention; and

FIG. 4 is a flow chart summarizing the process of the third embodiment of the present invention.

### DETAILED DESCRIPTION OF INVENTION

Preferred embodiments of the present invention will be described herein below with reference to the accompanying drawings. In the following description, well-known functions or constructions are not described in detail since they would obscure the invention in unnecessary detail.

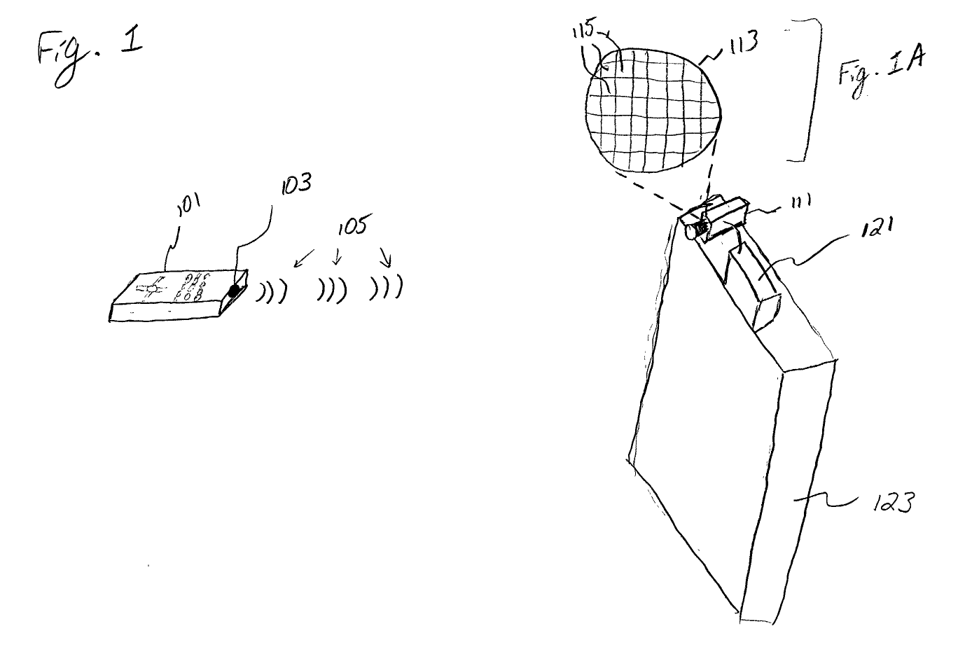

FIG. 1 is a representative view of a system according to an embodiment of the present invention. As shown in FIG. 1, hand-held device 101 is depicted as a standard remote control typically associated with a VCR or television. Incorporated into the hand-held device 101 is a control unit that causes an LED 103 to flash at a preset frequency. The starting of the flashing can be controlled by any switching method, for example, an on/off switch, a motion switch, or the device can be sensitive to user contact and the LED 103 can turn on when the user touches or picks up the device. Any other on/off method can be used, and the examples described herein are not meant to be restrictive.

After the flashing of the LED 103 is initiated, the transmitted light 105 is focused by camera 111 and incident on a portion of the light sensing surface of a digital camera 111. Typically, digital cameras use a 2D light-sensitive array that capture light that is incident on the surface of the array after passing though the focusing optics of the camera. The array comprises a grid of light sensitive cells, such as a CCD array, each cell being electrically connectable to another electronic elements, including an A/D converter, buffer and other memory, a processor and compression and decompression modules. In the present embodiment, the light from the pointing device is incident on array surface 113 made up of cells 115 shown in FIG. 1a (which is a exploded view of a portion of the array surface 113 of digital camera 111).

Each image of the digital camera 111 is typically “captured” when a shutter (not shown) allows light (such as light from LED 111) to be incident and recorded by light-sensitive surface 113. Although a “shutter” is referred to, it can be any equivalent light regulating mechanism or electronics that creates successive images on a digital camera, or successive image frames on a digital video recorder. Light that comprises the image enters the camera 111 when the shutter is open is focused by the camera optics onto a corresponding region of the array surface 113, and each light sensitive cell (or pixel) 115 records an intensity of the light that is incident thereon. Thus, the intensities captured in the light sensitive cells 115 collectively record the image.

Thus, flashing light 103 from the hand-held device 101 that enters the camera 111 is focused to approximately a point and recorded as an incident intensity level by one or a small group of pixels 115. The digital camera 111 processes and transmits the light level recorded in each pixel in digitized form to a control unit 121 in FIG. 1a.

Control unit 121 includes image recognition algorithms that detect and track light from the LED 103. Where light 105 from the LED 103 is flashing at a frequency that is on the same order as the shutter of camera 111, successive images of the light spot from the LED 103 will vary in intensity as the shutter and the flashing pattern of the LED 103 move in and out of synchronization. The control unit 121 may store image data for a number of successive images and an image recognition algorithm of the control unit 121 may thus search the image pixels for small light spots that vary in intensity upward and downward for successive images. Once a pattern is recognized, the algorithm concludes the position in the image corresponds to the location of the hand-held device 103. Alternatively, or in conjunction, an image recognition algorithm in the control unit 121 may search for and identify a region in the image with a dark background (the body of the hand-held device 101) and a bright center (comprising the light 105 emitted from the LED 103).

Once the location of the hand-held device 101 is recognized by the control unit 121 in the image, the location may be tracked for successive images by the control unit 121 using a known image tracking algorithm. Using such algorithms, the control unit focuses on the region of the image that corresponds to the location of the hand-held device 101 in the preceding image or images. The control unit 121 may look for the features of the hand-held device 101 in the image pixel data, such as a light spot surrounded by a darker immediate background (corresponding to the device 101 body).

The position of the hand-held device 101 as identified and tracked in the images by the control unit are mapped onto a display 123 and is used to control, for example, the position of a cursor, pointer, or other position element. For example, the position of the cursor on the display 123 may be corollated to the position of the position of the hand-held device in the image as follows:

Xdpy=scale*(Ximg−Xref) Eq. 1

In Eq. 1, vector Xdpy is the position of the cursor in a 2D reference coordinate system of display 123 (referred to as display space), vector Ximg is the position of the hand-held device 101 as identified by the control unit in the 2D image (referred to as the image space), vector Xref is a reference point in the image space and “scale” is a scalar scaling factor used by control unit to scale the image space to the display space. (It is noted that the bold type-face of Xdpy, Ximg, Xref and Xperson introduced below indicates vectors.) Reference point Xref is a reference point in the image that the control unit may locate in the image in addition to the location of the hand-held device 101 as previously described. Thus, the parenthetical portion of the right side of Eq. 1 corresponds to the distance the hand-held device 101 is moved in the image space from the reference point in the image. Thus, the position of the hand-held device 101 in the image space when moved is determined with respect to a constant reference point. Thus, the mapping of the device 101 as detected in the image space only changes when there is movement of the device 101 with respect to the reference point. Consequently, there is only corresponding movement of the cursor or like moveable feature in the display space when there is actual movement of the device 101 in image space. The reference point may be detected every time the flashing light is detected and reset when the light disappears, corresponding to when the user disengages and then re-engages the hand-held device 101.

It is clear that the system of the first embodiment described above may be readily adapted to detect and track a number of hand-held devices and may use the movement of each such device in the image space to move a separate cursor, pointing device, or other movable feature on the display. For example, two or more separate hand-held devices having flashing LEDs in the field of view of camera 111 of FIG. 1 will have the light focused on the light sensitive array 113. Each flashing LED is separately detected and tracked in the image by control unit 121 in the manner described above for a single hand-held device 101. The position of each is mapped by the control unit 121 from the image space to display space using Eq. 1 in the manner described above for a single hand-held device. Each such mapping may thus be used to control a separate cursor, etc. on the display 123.

Thus, each of the two or more hand-held devices may independently control a separate cursor or other movable feature on the display. Each cursor (or movable feature) moves on the screen independently of the other cursors (or movable features), since each cursor moves in response to one of the hand-held devices as mapped by the control unit 121. The two or more hand-held devices may have an identical flashing frequency or pattern, or they may have different frequencies, which may allow the control unit 121 to be programmed to more readily identify and/or discriminate the light signals emitted. In addition, the LEDs may emit light of different wavelengths, which likewise enables the control unit 121 to more readily identify and/or discriminate the light signals emitted in the images. The emitted light may be any wavelength of visible light that may be detected by the camera. If the camera can detect wavelengths outside of visible light, for example, infrared light, the hand-held device(s) may emit at that wavelength.

In addition, the system may comprise a training routine that enables the control unit to learn the flashing characteristics, wavelength, etc. of one or more hand-held devices. When the training routine is engaged by the user, for example, the instructions may direct the user to hold the hand-held device at a certain distance directly in front of the camera 111 and initiate flashing of the LED 103. The control unit 121 records the flashing frequency or pattern of the device 101 from successive images. It may also record the wavelength and/or image profile of the hand-held device 101. This data may then be used by the control unit 121 thereafter in the recognition and tracking of the hand-held device 101. Such a training program may record such basic data for a multiplicity of hand-held devices, thus facilitating later detection and tracking of the hand-held device(s) by the system.

The processing of the control unit relating to Eq. 1 described above may be modified such that mapping between the image space and the display space for the hand-held device is done relatively to the position of the user carrying the hand-held device, as follows:

Xdpy=scale*(Ximg−Xref−Xperson) Eq. 2

In Eq. 2, the vector Xperson is the coordinate position of the user holding the device, for example, a point in the center of the user's chest. Thus, the coordinates given in the parenthesis only change if the vector position Ximg of the hand held device in the image changes with respect to vector (Xref+Xperson), namely, with respect to the position of the person as located by the reference point. The person may consequently move about the room with the hand-held device 103, and the control unit will only map a change in position of the hand-held device 101 from image space to display space when the hand-held device 101 is moved with respect to the user.

Xperson may be detected in the image by the control unit by using a known image detection and tracking algorithm for a person. As noted, the Xperson coordinates may be a central point on the user, such as a point in the middle of the user's chest. As before, Xref may be detected and set each time the flashing light on the hand-held device 101 is detected. The scale factor may also be set to be inversely proportional to the size of the body (e.g., the width of the body), so that the mapping becomes invariant to the distance between the camera and the user(s). Of course, if the system uses mapping corresponding to Eq. 2 in its processing, it may adapt the processing to detect, track and map multiple hand-held devices wielded by multiple users, in the manner described above.

Alternatively, the processing may be further adapted to track movement of the hand-held device only with respect to the person, thus avoiding cursor movement on the display if the user moves, as in the processing corresponding to Eq. 2. However, in Eq. 2, the reference coordinate point is taken to be the origin (i.e., zero vector), or, equivalently, the vector Xref in Eq. 1 is taken to be a movable reference point, namely vector Xperson as described above. Thus, the control unit 121 has mapping algorithms corresponding to:

Xdpy=scale*(Ximg−Xperson) Eq. 3

In Eq. 3, the parenthetical portion of the equation (corresponding to the image space) determines the movement of the hand-held device Ximg with respect to the vector Xperson, for example, the movement of the remote with respect to a point in the center of the user's chest. Thus, the mapping from image space to display space again only changes when the hand-held device moves relative to the person, and not when the user moves while holding the device steady. The same result is accomplished as for mapping corresponding to Eq. 2, but with less image recognition and mapping processing by control unit 121.

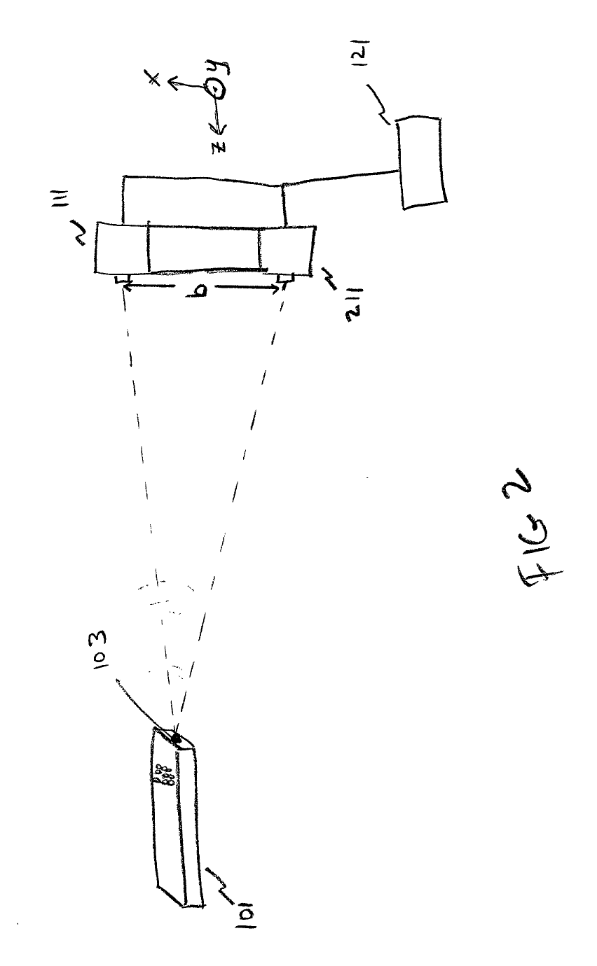

FIG. 2 depicts a second embodiment of the present invention, which is analogous to the first embodiment, but comprises at least one additional digital camera. As described herein, the addition of at least one camera to the system enables the system to detect and quantify a depth movement (i.e., a movement of the device 101 in the Z direction, normal to the image plane of the cameras 111, 211, shown in FIG. 2) of the hand-held device using, for example, stereo triangulation algorithms applied to the images of the separate cameras. The movement and quantifying of movement in the Z direction, in addition to movement in two dimensions (i.e., the X-Y plane as shown in FIG. 2) described above for the first embodiment, enables the system to map an image space to a 3D rendering of a cursor or other movable object in display space.

Thus, in the system of FIG. 2, positions of the hand-held device 101 are detected and tracked by the control unit 121 for two images, namely one image of the device 101 from camera 111 and another from camera 211. Two of the dimensions of the hand-held device 101 in the image space, namely the planar image coordinates (x,y) of the device in the image plane of the camera, may be determined directly from one of the images.

Data corresponding to a movement of the hand-held device in and out (i.e., in the Z direction shown in FIG. 2) may be determined by using the planar image coordinates (x,y) and the planar image coordinates (x′,y′) of the image of the hand-held device in the second image. The Z coordinate of the hand-held device in real space in FIG. 2 (as well as the X and Y coordinates with respect to a known reference coordinate system in real space) may be determined using standard techniques of computer vision known as the “stereo problem”. Basic stereo techniques of three dimensional computer vision are described for example, in “Introductory Techniques for 3-D Computer Vision” by Trucco and Verri, (Prentice Hall, 1998) and, in particular, Chapter 7 of that text entitled “Stereopsis”, the contents of which are hereby incorporated by reference. Using such well-known techniques, the relationship between the Z coordinate of the hand-held device in real space and the image position of the device in an image of the first camera (having known image coordinates (x,y)) is given by the equations:

x=X/Z Eq. 4a

Similarly, the relationship between the position of the hand-held device and the second image position of the device in an image of the second camera (having known image coordinates (x′,y′)) is given by the equations:

x′=(X−D)/Z Eq. 4b

where D is the distance between cameras 111, 211. One skilled in the art will recognize that the terms given in Eqs. 4a-4b are up to linear transformations defined by camera geometry.

Solving Eqs. 4a and 4b for Z:

Z=D/(x−x′) Eq. 4c

Thus, by determining the x and x′ position of the hand-held device in the images captured from cameras 111, 211, respectively, for successive images, the control unit 121 may determine the change in position of the hand-held device in the Z direction, namely in and out of the plane captured by the images. In a manner analogous to that described above, the movement of the person in the Z direction may be eliminated, such that it is the Z movement of the device 101 with respect to the user that is determined.

When there is a change in the Z direction detected by the control unit 121, the control unit may scale the Z movement in real space to the image, such that there is a depth dimension in addition to the planar dimensions (such as (x,y) if the image of the first camera is used to track and map changes) in the image space. Thus, the control unit 121 may map an image space that includes a depth dimension to a 3D rendering of a cursor or other movable feature in the display space. Thus, in addition to the cursor moving up/down and left/right in the display corresponding to up/down and left/right movement by the hand-held device, a movement of the hand-held device toward or away from the cameras 111, 211 results in a corresponding 3D rendering of the cursor movement in and out of the display.

Since cursor movement is mapped from the coordinates of the hand-held device in image space, no camera calibration is required. (Even in the depth case, Eq. 4c is a function of image coordinates x, x′; in addition, the separation distance D may be fixed in the system and known to the control unit 121.) Also, since the flashing light detection algorithm will implicitly solve the point-correspondences problem, measuring 3D displacements is relatively simple and requires little computation.

As described above for the first embodiment, the second embodiment (that includes at least a second camera that is used to detect depth data, which is used in mapping the image space to the display space) may include device training processing and may also detect, track and map multiple hand-held devices wielded by multiple users. Thus, two or more hand-held devices may each independently control a separate cursor or other movable feature on the display. Each cursor (or movable feature) moves on the screen independently of the other cursors (or movable features), since each cursor moves in response to one of the hand-held devices as mapped by the control unit 121. The two or more hand-held devices may have an identical flashing frequency or pattern, or they may have different frequencies. In addition, the LEDs may emit light of different wavelengths, which likewise enables the control unit 121 to more readily identify and/or discriminate the light signals emitted in the images. The emitted light may be any wavelength of visible light that may be detected by the camera. If the camera can detect wavelengths outside of visible light, for example, infrared light, the hand-held device(s) may emit at that wavelength.

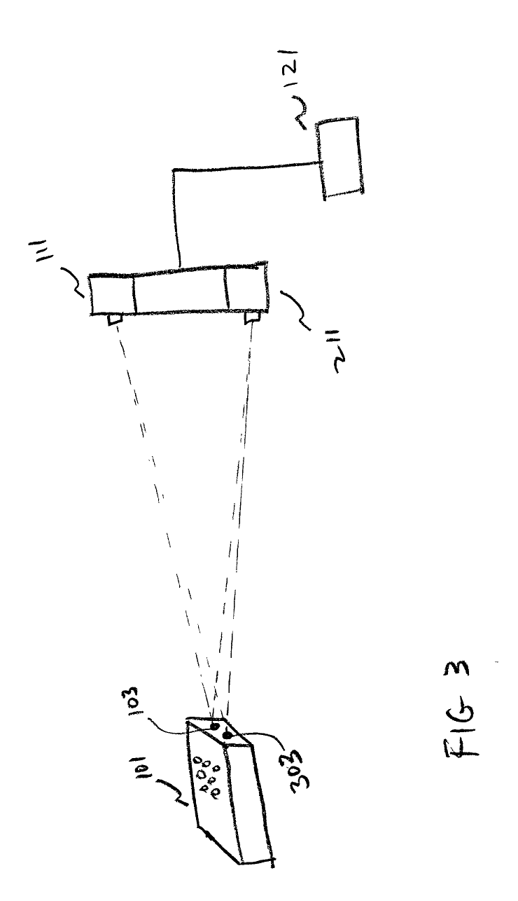

FIG. 3 depicts a third embodiment of the present invention that incorporates at least two cameras 111, 211 (as in the second embodiment), and at least two LEDs 103, 303 in the hand-held device 101. The addition of at least one more LED into the hand-held device 101 enables the system to calculate all six degrees of motion (three translation and three rotational). The three translation degrees of motion are detected and mapped from the image space to the display space as in the second embodiment described above, and will thus not be repeated here.

As to detection and mapping of the rotational motion of the hand-held device, as noted above, hand-held device 101 in FIG. 3 incorporates a second Led 303 into the transmitter. Light emitted from each LED 103, 303 is separately detected and tracked by camera 111. (Light emitted by each LED 103,303 is also separately detected by camera 211, but since the images from the second camera are only used to determine depth motion of the hand-held device 101, only the image of the first camera is considered in the rotational processing.) This separate detection and tracking is analogous to the detection and tracking of two separate hand-held devices in the discussion of the embodiment of FIG. 1. Thus, control unit 121 analyzes the image using image detection processing and, as described above, detects two spots on the images that it identifies as coming from two flashing LEDs 101, 303. By the proximity of the light spots in the image, the control unit 121 determines that the light spots are from LEDs on one hand-held device. The determination may be made in other manners, for example, the image recognition software may see that the light spots are both on the same dark background that it recognizes as the body of the device 101.

The relative movement of the two spots in successive images as detected by the control unit indicate a rotation (roll) of the hand-held device along the axis of light emission. Other changes in the relative position of the light spots in the image, such as the distance between them, may be used by control unit 121 to determine pitch and yaw of the device 101. The data mapped from the image space to the display space may thus include 3D data and data for three rotational degrees of freedom. Thus, the mapping may provide for rotational and orientational movement of the cursor or other movement device in a 3D rendering on the display.

In like manner as described above for the first embodiment, the system can detect and track multiple hand-held devices wielded by multiple users. Thus, two or more hand-held devices may each independently control a separate cursor or other movable feature on the display. Each cursor (or movable feature) moves on the screen independently of the other cursors (or movable features), since each cursor moves in response to one of the hand-held devices as mapped by the control unit 121. The two or more hand-held devices may have an identical flashing frequency or pattern, or they may have different frequencies. In addition, the LEDs may emit light of different wavelengths, which likewise enables the control unit 121 to more readily identify and/or discriminate the light signals emitted in the images. As noted above in the description of the first embodiment, the light from LEDs 101, 103 may be more readily differentiated in the images by the control unit if they flash at different frequencies and/or have different wavelengths. The emitted light may be any wavelength of visible light that may be detected by the camera. If the camera can detect wavelengths outside of visible light, for example, infrared light, the hand-held device(s) may emit at that wavelength.

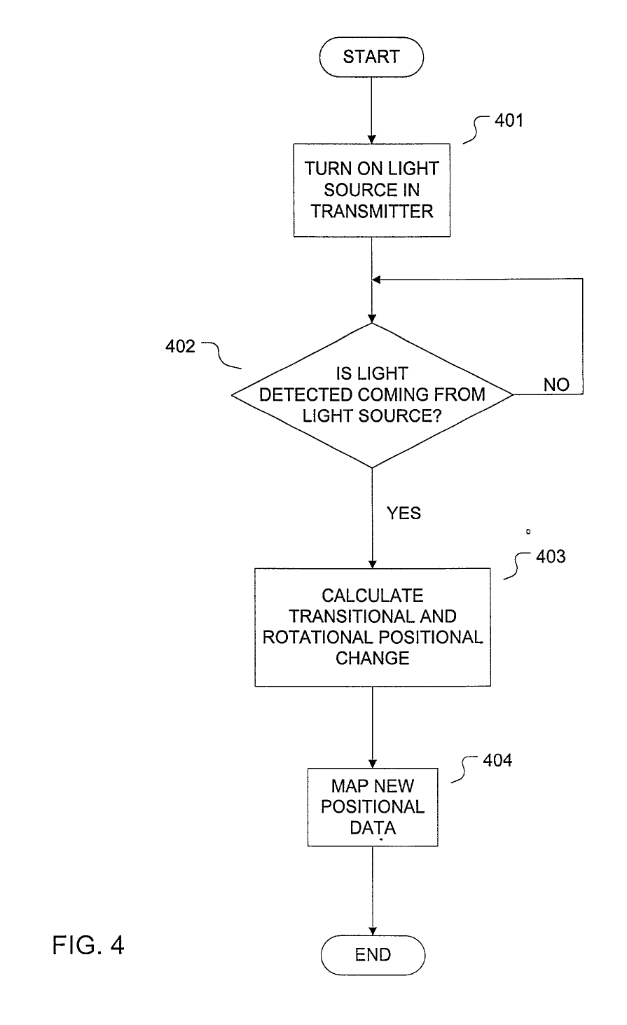

The wireless pointing system will now be described with reference to FIG. 3 and FIG. 4. FIG. 4 is a flow diagram of the process of the present invention. In step 401 the LEDs 103 and 303 are turned on by a user handling the hand-held device 101, in this case a remote. In step 402 the system, via the images transmitted by cameras 111, 211 to control unit 121, determines if light is detected emanating from the remote 101. If no light is detected the process returns to step 402. If light is detected, control unit in step 403 calculates a change in 3D position and rotation in three degrees of freedom from successive images captured and transferred from cameras 111, 211, as described above with respect to the third embodiment. Control unit 121 in step 404 maps the position and rotation of the remote 101 from image space to display space, where it is used in a 3D rendering of a cursor. A cursor need not even be displayed. Instead, the pointing device, according to a second embodiment of the present invention, can control the movement of the display in a virtual reality computer space, or navigate between different levels of a 2-dimensional or a 3-dimensional grid.

In addition to the above advantages of the present invention, the present invention also has great commercial advantages. All of the expensive components (e.g. cameras and processors) are not contained in the transmitter. The minimum components the transmitter contains are an oscillator, LED, and connecting components. A commercial application of the invention, of course, is interactive video games, where the user can use the remote or other hand-held device to control movement of a player about in a 3D rendering in the display space. In addition, the cameras can be incorporated into various other systems, for example, teleconferencing systems, videophone, video mail, etc, and can be easily upgraded to incorporate future developments. Also, the system is not confined to a single pointing device or transmitter. With short setup procedures the system can incorporate multiple transmitters to allow for multi-user functionality. Detection by the system is not dependent on the wavelength or even the frequency of the light emitted by the hand-held device.

The mapping of movement of the hand-held device from image space to display space may be applied to applications other than cursor movement, player movement, etc. 3D mapping schemes range from the direct mapping between real-world coordinates and 3D-coordinates in a virtual world rendered in the display system to more abstract representation in which the depth is used to control another parameter in a data navigation system. Examples of these abstract schemes are numerous: For example, in a 3D navigational context, 2D pointing may allow selection in the plane, while 3D pointing may also allow control in an abstract depth, for example, to adjust the desired relevance in the results of the electronic program guide (EPG) recommendation and/or manual control of a pan-tilt camera (PTC). In another context, 2D pointing allows selection of hyper-objects in video content, TV programs, for example, for purchasing goods on-line. Also, the pointing device may be used as a virtual pen to write in the display, which may include virtual handwritten signatures (including signature recognition) that may again be used in e-shopping or for other authorization protocols, such as control of home appliances. As noted above, in video game applications, the system of the present invention may enable multiple user interaction and navigation in virtual worlds. Also, in electronic pan/tilt/zoom (EPTZ) based videoconferencing, for example, targets may be selected by a participant by pointing and clicking on an image on the display, zooming features may be controlled, etc.

In addition, while the cameras 111, 211 in the above embodiments have been characterized as being used to capture images to detect and track the hand-held device(s), they may also serve other capabilities, such as teleconferencing and other transmissions of images, and other image recognition and processing.

Thus, while the invention has been shown and described with reference to certain preferred embodiments thereof, it will be understood by those skilled in the art that various changes in form and details may be made therein without departing from the spirit and scope of the invention as defined by the appended claims.

What is claimed is:

1. A system, comprising:
at least one light source in a movable hand-held device;
at least one light detector that detects light from said light source; and
a control unit that receives image data from the at least one light detector,
wherein the control unit detects the position of the hand-held device in at least two-dimensions from the image data from the at least one light detector and translates the position to control a feature on a display.

2. The system of claim 1, wherein the at least one light detector is a digital camera.

3. The system of claim 2, wherein the digital camera captures a sequence of digital images that include the light emitted by the hand-held device, the sequence of digital images transmitted to the control unit.

4. The system of claim 3, wherein the control unit comprises an image detection algorithm that detects the image of the light of the hand-held device in the sequence of images transmitted from the digital camera.

5. The system of claim 4, wherein the control unit maps a position of the detected hand-held device in the images to a display space for the display.

6. The system as in claim 5, wherein the mapped position in the display space controls the movement of a feature in the display space.

7. The system as in claim 6, wherein the feature in the display space is a cursor.

8. The system of claim 3, wherein the captured images are processed by the control unit for at least one other purpose.

9. The system of claim 8, wherein the at least one other purpose is selected from the group of teleconferencing, image transmission, and image recognition.

10. The system of claim 1, wherein said at least one light source is an LED.

11. The system of claim 1, wherein the at least one light detector comprises two digital cameras.

12. The system of claim 11, wherein the two digital camera each capture a sequence of digital images that include the light emitted by the hand-held device, each sequence of digital images transmitted by each camera to the control unit.

13. The system of claim 12, wherein the control unit comprises an image detection algorithm that detects the image of the light of the hand-held device in each sequence of images transmitted from the two digital cameras.

14. The system of claim 13, wherein the control unit comprises a depth detection algorithm that uses the position of the light in the images received from each of the two cameras to determine a depth parameter from a change in a depth position of the hand-held device.

15. The system of claim 14, wherein the control unit maps a position of the detected hand-held device in at least one of the images from one of the cameras and the depth parameter to a 3D rendering in a display space for the display.

16. The system as in claim 15, wherein the mapped position in the display space controls the movement of a feature in the 3D rendering in the display space.

17. The system of claim 1, wherein the at least one light detector is at least one digital camera and the hand-held device comprises two light sources.

18. The system of claim 17, wherein the digital camera captures a sequence of digital images that include the light from the two light sources of the hand-held device, the sequence of digital images transmitted to the control unit.

19. The system of claim 18, wherein the control unit comprises an image detection algorithm that detects the image of the two light sources of the hand-held device in the sequence of images transmitted from the digital camera.

20. The system of claim 19, wherein the control unit determines at least one angular aspect of the hand-held device from the images of the two light sources.

21. The system of claim 20, wherein the control unit maps the at least one angular aspect of the hand-held device as detected in the images to a display space for the display.

22. The system of claim 1, wherein the light source emits at a wavelength falls that falls within the visible and infrared light spectrum.

23. A system comprising:
two or more movable hand-held devices, each hand-held device comprising at least one light source,
at least one light detector detecting light from the at least one light source of each of the two or more hand-held devices
a control unit that receives image data from the at least one light detector,
wherein the control unit detects the positions for each of the two or more movable hand-held devices in at least two dimensions from the image data from the at least one light detector and translates the positions for each of the two or more movable hand-held devices to separately control two or more respective features on a display.

24. The system of claim 23, wherein the at least one light source of the two or more hand-held devices each turn on and off at a flashing frequency and emit light at a flashing wavelength.

25. The system of claim 24, wherein the flashing frequencies of the at least one light source of the two or more hand-held devices are different.

26. The system of claim 24, wherein the flashing wavelengths of the at least one light source of the two or more hand-held devices are different.

27. The system of claim 26, wherein the flashing wavelength falls within the visible and infrared light spectrum.
